(19) United States
(12) Patent Application Publication
(10) Pub. No.: US 2016/0261139 A1
(43) Pub. Date: Sep. 8, 2016

(54) Multipurpose Charging and Display Stand for a Computerized Wristwatch

(71) Applicant: Michael Kidakarn, Pasadena, CA (US)

(72) Inventor: Michael Kidakarn, Pasadena, CA (US)

(21) Appl. No.: 15/064,083

(22) Filed: Mar. 8, 2016

Related U.S. Application Data
(60) Provisional application No. 62/129,913, filed on Mar. 8, 2015.

(51) Int. Cl. H02J 7/02; G04G 19/02; A47F 7/02; H02J 7/00

(52) U.S. Cl. CPC H02J 7/025; H02J 7/0042; G04G 19/02; A47F 7/022

(57) ABSTRACT

A multipurpose charging and display stand is configured to: retain a computerized wristwatch, such as an Apple™ and a Lightning™ smartwatch, in multiple vantage points to enable facilitated access to components on the computerized wristwatch, allow for charging of the computerized wristwatch through induction or direct cables, and allow for adjustable mounting of the computerized wristwatch to facilitate viewing of a display screen. The stand also enables compatible communication devices and accessories to communicate with the computerized wristwatch. A base forms a foundation for the stand and includes a cavity for storage of a power cable and other items. The base supports a post that extends at an angle. A leather arm rotatably joins with the post at a perpendicular orientation. The arm includes an inductive charging member that mates with the computerized wristwatch for charging. Alternatively, a power cable extends form the arm to charge the computerized wristwatch.

### CROSS REFERENCE OF RELATED APPLICATIONS

This application claims the benefits of U.S. provisional application No. 62129913 filed Mar. 8, 2015 and entitled SMARTWATCH CHARGING AND DISPLAY STAND, which provisional application is incorporated by reference herein in its entirety.

### FIELD OF THE INVENTION

The present invention relates generally to a multipurpose charging and display stand for a computerized wristwatch. More so, a multipurpose charging and display stand retains a computerized wristwatch, such as a smartwatch, at multiple vantage points to enable facilitated access to components on the computerized wristwatch, allows for charging of the computerized wristwatch through induction or direct cables, and allows for adjustable mounting of the computerized wristwatch to facilitate viewing of a display screen on the smart watch and compatible communication devices that are in communication with the smartwatch.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a wristwatch is a small timepiece intended to be carried or worn on the wrist, or fastenable by a tether. Often, the wristwatch is designed to be worn on a wrist, attached by a watch strap or other type of bracelet. The wristwatch is designed to operate despite the motions caused by a person's activities. It is known that a computerized wristwatch, or “smartwatch”, provides functionality that is enhanced beyond timekeeping. It is known that the smartwatch is compatible with a mobile society, where interconnection with others is imperative.

The smartwatch can also perform basic tasks, such as calculations, translations, and game-playing. In essence, smartwatches are effectively wearable computers. Many smart watches also run mobile apps, using a mobile operating system. Most smartwatches have a rechargeable battery and graphical display and many have a touch screen. Peripheral devices may include camera, thermometer, accelerometer, altimeter, barometer, compass, GPS receiver, speaker, and an SD card that is recognized as a mass storage device by a computer.

Often, the smartwatch comes with an internal, rechargeable battery, such as a lithium-ion battery. Generally, the rechargeable battery is a type of electrical battery which can be charged, discharged into a load, and recharged many times. The rechargeable battery utilized by the smartwatch requires periodic recharging. Charging is preferred because replacing the rechargeable battery can be problematic. For the most part, a replacement of the rechargeable battery requires taking the smartwatch apart and disturbing the internal hardware.

Other proposals have involved displaying and charging smartwatches and other similar communication devices. The problem with these display and charging devices is that they do not allow for efficient display and charging of the smartwatch. Even though the above cited display stands and chargers meet some of the needs of the market, a a multipurpose charging and display stand retains a computerized wristwatch, such as a smartwatch, at multiple vantage points to enable facilitated access to components on the computerized wristwatch, allows for charging of the computerized wristwatch through induction or direct cables, and allows for adjustable mounting of the computerized wristwatch to facilitate viewing of a display screen on the smart watch and compatible communication devices that are in communication with the smartwatch is still desired.

### SUMMARY

Illustrative embodiments of the disclosure are generally directed to a multipurpose charging and display stand for a computerized wristwatch. The multipurpose charging and display stand, hereafter “stand”, serves retain a computerized wristwatch, such as an Apple™ and a Lightning™ smartwatch, at multiple vantage points to enable facilitated viewing and access to components on the computerized wristwatch. The stand is also effective for efficient charging of the computerized wristwatch through induction or direct cables. The stand is adjustable to enable adjustable mounting of the computerized wristwatch. This helps facilitate viewing of a display screen on the computerized wristwatch. The stand also enables communication devices and accessories that are compatible with the computerized wristwatch to communicate with the computerized wristwatch.

In some embodiments, the stand comprises a base that forms a supportive foundation for the stand and the computerized wristwatch. The base may be defined by a cavity. The cavity is sized and dimensioned to store a power cable and other items. The base is configured to support a post that extends from the base at an angle. An arm rotatably joins with the post at a substantially perpendicular orientation. The computerized wristwatch detachably joins with the arm for display and charging. The arm includes an inductive charging member that mates with a base on the computerized wristwatch. The arm has a substantially leather fabrication to reduce cold temperatures on the computerized wristwatch. A power cable extends form the arm to charge the computerized wristwatch.

One aspect of a multipurpose charging and display stand for charging and displaying a computerized wristwatch, comprises:
a base, the base defined by a mounting surface, at least four sidewalls, and an opening, the opening forming a cavity inside the base;
a groove, the groove disposed to extend along a longitudinal axis of the base;
a protruding member, the protruding member disposed to extend from the mounting surface into the cavity;
a panel, the panel disposed to detachably overlay the opening of the base;
a post, the post defined by a base end and an arm end, the base end configured to extend from the base at an angle;
an arm, the arm disposed to rotatably join with the arm end of the post at a generally perpendicular orientation, the arm defined by a substantially triangular shape, the arm further defined by a substantially a durable and flexible material composition;
an inductive charging member, the inductive charging member disposed on the arm, the inductive charging member configured to at least partially enable the transfer of energy from the arm; and
a power cable, the power cable configured to at least partially enable the transfer of energy from the arm, the power cable further configured to stow inside the cavity, wherein the power cable is substantially hidden from view when the panel overlays the opening of the cavity.

In another aspect, the stand is configured to display and charge a computerized wristwatch.

In another aspect, the computerized wristwatch is a smartwatch.

In another aspect, the smartwatch is an Apple™ watch and a Lightning™ watch.

In another aspect, the inductive charging member is configured to rotatably engage the computerized wristwatch for charging.

In another aspect, the inductive charging member operatively joins the arm to enable wireless charging of the computerized wristwatch.

In another aspect, the inductive charging member is configured to rotatably disengage the computerized wristwatch for enabling optimal viewing and operation of a display screen on the computerized wristwatch.

In another aspect, the power cable and the inductive charging member are configured to alternate charging functions.

In another aspect, the power cable carries energy from an external power source, through the arm, and to the smartwatch.

In another aspect, the power cable carries energy from an internal power source in the arm.

In another aspect, the base forms a generally tapered shape.

In another aspect, the sidewalls comprise a cable notch, the cable notch configured to enable passage of the power cable from the cavity.

In another aspect, the groove comprises a groove latch.

In another aspect, the power cable is configured to wind around the protruding member for stowage.

In another aspect, the panel has a lip configured to enable secure fastening with the sidewalls of the base.

In another aspect, the post has a substantially flat shape.

In another aspect, the durable and flexible material composition of the arm is leather.

One objective of the present invention is to provide a secure retention for the smartwatch to minimize scratching and damage.

Another objective is to enable optimal viewing of the smartwatch's display screen, notifications, time, media, and menus.

Another objective is to provide a display and recharging stand that enables the smartwatch to be quickly accessed.

Another objective is to eliminate the need to set the smartwatch on the table or floor, thus preventing the smartwatch from damage, scratches from the surface, and being accidentally stepped on.

Another objective is to provide a cable management system that is enclosed under the panel for organization, a protruding member for the power cable to wrap around, and a panel to hide the power cable and circuitry.

Another objective is to provide a storage compartment for the power cable, circuitry, earphones, and other small accessories.

Another objective is to charge the smartwatch through both inductive energy transfer and power cable energy transfer.

### BRIEF DESCRIPTION OF THE DRAWINGS

The invention will now be described, by way of example, with reference to the accompanying drawings, in which:

FIG. 1 illustrates a perspective view of an exemplary display and charging stand, in accordance with an embodiment of the present invention;

FIG. 2 illustrates a perspective view of an exemplary display and charging stand supporting an exemplary computerized wristwatch, in accordance with an embodiment of the present invention;

FIG. 3 illustrates a perspective view of an exemplary display and charging stand with an exemplary panel covering a cavity, in accordance with an embodiment of the present invention;

FIG. 4 illustrates a perspective view of an exemplary display and charging stand with the panel detached from a base, in accordance with an embodiment of the present invention;

FIG. 5 illustrates a perspective view of an exemplary display and charging stand with an exemplary inductive charging member, in accordance with an embodiment of the present invention; and

FIG. 6 illustrates a perspective view of an exemplary display and charging stand with an exemplary power cable, in accordance with an embodiment of the present invention.

Like reference numerals refer to like parts throughout the various views of the drawings.

### DETAILED DESCRIPTION OF THE INVENTION

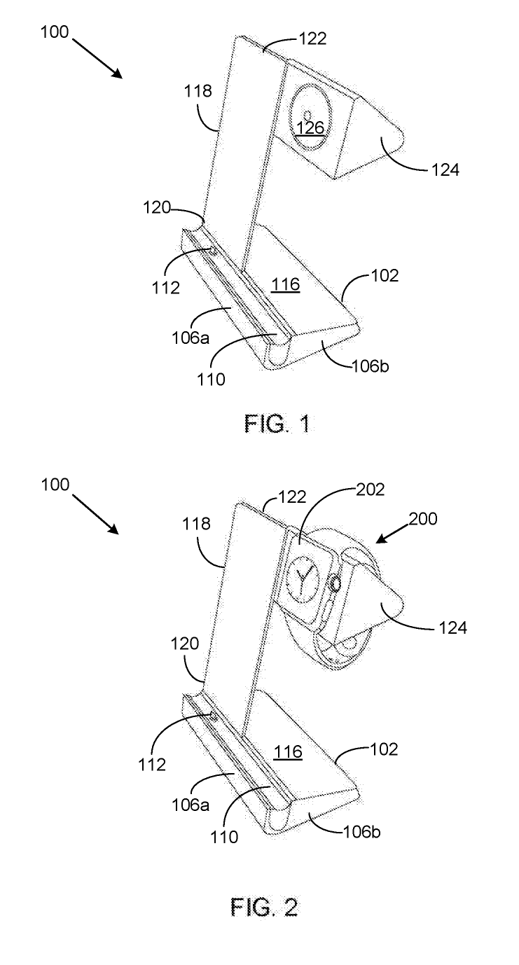

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-6, a multipurpose charging and display stand 100 is configured to: retain a computerized wristwatch 200, such as an Apple™ and a Lightning™ smartwatch, in multiple vantage points to enable facilitated access to components on the computerized wristwatch 200, allow for charging of the computerized wristwatch 200 through direct induction or direct cables, and allow for adjustable mounting of the computerized wristwatch 200 to facilitate viewing of a display screen on the computerized wristwatch 200.

In some embodiments, the multipurpose charging and display stand 100, hereafter “stand 100”, also enables compatible communication devices and accessories to communicate with the computerized wristwatch 200. A base 102 forms a foundation for the stand 100 and includes a cavity for storage of a power cable 128 and other items that may be pertinent to the computerized wristwatch 200. The base 102 supports a post 118 that extends at an angle. A leather arm 124 rotatably joins with the post at a perpendicular orientation. The arm 124 includes an inductive charging member 126 that mates with the computerized wristwatch for charging. Alternatively, a power cable extends form the arm 124 to charge the computerized wristwatch 200. In essence, the stand 100 is efficacious for retaining the computerized wristwatch 200 for storage, display, and charging functions.

Those skilled in the art will recognize that the unique configuration of the stand 100 provides numerous hidden advantages that enhance use of the computerized wristwatch 200. In one embodiment, the stand 100 utilizes an arm 124 that retains the computerized wristwatch 200 in a substantially horizontal orientation. The material composition of the arm 124 is such that the computerized wristwatch 200 does not become cold and uncomfortable. For example, the arm 124 may have a durable and flexible material composition, such as leather, that engages a metal watch head 102 of the computerized wristwatch 200. The leather is known in the art as not being conducive to creating cold metal. The arm 124 may have a substantially triangular shape with three distinct surfaces that securely hold the computerized wristwatch 200, so as to minimize undesirable rotation of the computerized wristwatch 200.

In some embodiments, the arm 124 may rotatably adjust so further enhance viewing and displaying the computerized wristwatch 200. For example, the vantage point can be tilted upwardly to provide a better view of a display screen on the computerized wristwatch 200. Those skilled in the art will recognize that the computerized wristwatch 200 may be used to calculate, compute, operate, and view data. Generally, a display screen on the computerized wristwatch 200 provides visual functionality. The arm 124 securely retains the display screen at a desired vantage point. In this manner, the optimal viewing vantage point of the display screen is achieved. Additionally, the computerized wristwatch 200 may be engaged and operated while being supported on the arm 124.

In another embodiment, the arm 124 includes an inductive charging member 126. The inductive charging member 126 is configured to directly engage a back part on the watch head 202 on the computerized wristwatch 200 through an inductive coupling. In this manner, the computerized wristwatch 200 may be charged without wiring. Those skilled in the art will recognize that an electromagnetic field easily transfers from the inductive charging member 126 to the watch head 202 on the computerized wristwatch 200.

In another embodiment, a power cable 128 directly transfers energy from a power source, through the arm 124, before charging the computerized wristwatch 200. The power cable 128 may originate from an external power source, or from an internal power source in the arm 124. A cavity at a base 102 of the stand 100 may include a protruding member 114 that enables winding of the power cable 128, such that the power cable 128 and other circuitry remains hidden from view. A panel 116 may cover the cavity and the contained power cable 128. This creates a clean, unobstructed view.

As shown in FIG. 1, the smartwatch charging and display stand 100 retains a computerized wristwatch 200 in multiple vantage points to enable facilitated access, allows for charging through induction or direct cables, and allows for adjustable mounting to facilitate viewing of a display screen on the smart watch and compatible communication devices that are in communication with the computerized wristwatch 200. The station 100 is configured to display and charge a computerized wristwatch 200. The computerized wristwatch 200 may include, without limitation, an Apple™ watch and a Lightning™ watch. However in other embodiments, additional types of smartwatches 200 and standard watches may be compatible with the stand 100.

Turning now to FIG. 2, the stand 100 comprises a base 102. The base 102 is defined by a mounting surface 104, at least four sidewalls 106a-d, and an opening 108. In some embodiments, the four sidewalls 106a-d may form a generally tapered, triangular shape. The base 102 is sufficiently stable so as to maintain balance of the stand 100 and the accompanying computerized wristwatch 200 on a flat surface. The opening 108 in the base 102 forms a cavity. The cavity may be used to store a power cable 128, circuitry, earphones, and other small accessories. A cable notch 132 may be disposed along any of the sidewalls 106a-d. The cable notch 132 is configured to enable passage of a power cable 128 that is stowed in the cavity. Suitable materials for the base 102 may include, without limitation, a rigid polymer, polyurethane, polyvinyl chloride, rubber, aluminum, metal alloys, fiberglass, and wood.

A groove 110 is disposed adjacently to the base 102. The groove 110 extends along a longitudinal axis of the base 102. The groove 110 may be used for retaining writing instruments, a power cable 128, circuitry, earphones, and other small accessories. A groove latch 112 may extend from one end of the groove 110. The grove may form a generally concave shape so as to retain the aforementioned items more securely. The groove 110 may be constructed from the same materials as the base 102.

The stand 100 may further include a protruding member 114 that extends from the mounting surface 104 and into the cavity. The protruding member 114 is configured to enable winding the power cable 128 for stowage. In one embodiment, the protruding member 114 has a narrow foundation end that engages the mounting surface 104 of the base 102, and a wider top end that bifurcates into opposite ends. The power cable 128 may wind around the protruding member 114 for enhancing organization and hidden stowage.

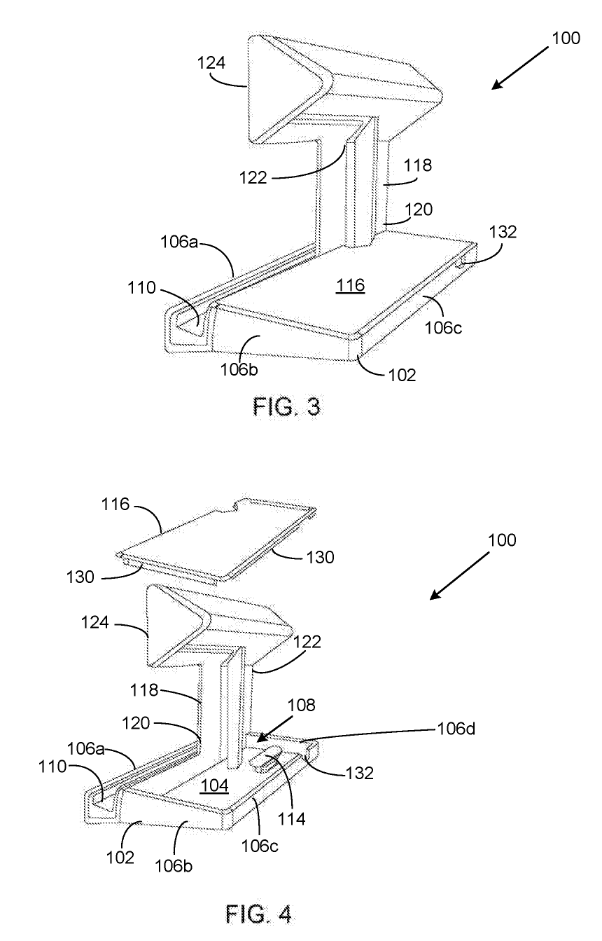

As referenced in FIGS. 3 and 4, the stand 100 may further include a panel 116. The panel 116 is disposed to detachably overlay the opening 108 of the base 102. The panel 116 may include a generally flat shape having a perimeter that substantially matches the opening 108 of the base 102. The panel 116 may be sufficiently rigid so as to form a protective overlay. FIG. 3 illustrates the panel 116 overlaying the cavity. FIG. 4 illustrates the panel 116 detached from the opening 108 of the cavity.

In some embodiments, a lip 130 may form at the perimeter of the panel 116 to fasten the panel 116 into place. The lip 130 frictionally engages the periphery of the sidewalis 106a-d. The stand 100 may further include a post 118. The post 118 is defined by a base end 120 and an arm end 122. The post 118 is disposed to extend at an angle from the base 102. The post 118 has a substantially flat shape. The post 118 extends at an angle such that the computerized wristwatch 200 is more easily accessed.

The stand 100 may further include an arm 124. The arm 124 is disposed to rotatably join with the arm end 122 of the post 118 at a generally perpendicular orientation. The arm 124 serves to hold the computerized wristwatch 200 in a suspended position so that the computerized wristwatch 200 does not need to be set on the table or floor, thus preventing the computerized wristwatch 200 from damage, scratches from the surface, and being accidentally stepped on. In one embodiment, the arm 124 retains the computerized wristwatch 200 in a substantially horizontal orientation.

The arm 124 is defined by a substantially triangular shape that forms three distinct sides. The generally circular shape of the computerized wristwatch 200 hangs onto each junction of the sides to form a secure attachment for hanging the computerized wristwatch 200 thereto (FIG. 2). In this manner, undesirable rotation of the computerized wristwatch 200 is maintained. In this manner, the triangular shape ensures a secure retention for the computerized wristwatch 200 to minimize scratching, damage, and being accidentally stepped on. Furthermore, the rotatable configuration of the arm 124 enables the computerized wristwatch 200 to be viewed from an optimal vantage point.

The material composition of the arm 124 is such that the computerized wristwatch 200 does not become cold and uncomfortable while being worn on the wrist. For example, the arm 124 may have a durable and flexible material composition, such as leather, that engages the metal base 102 of the computerized wristwatch 200. The leather is known in the art as not being conducive to creating cold metal.

The arm 124 may rotatably adjusts so further enhance viewing and displaying the computerized wristwatch 200. It is known that the computerized wristwatch 200 is operable to calculate, compute, operate, and view data. A display screen on the computerized wristwatch 200 provides visual functionality. The arm 124 securely retains the display screen at a desired vantage point. In this manner, the optimal viewing vantage point of the display screen is achieved. Additionally, the computerized wristwatch 200 may be engaged and operated while retained on the arm 124 of the stand 100.

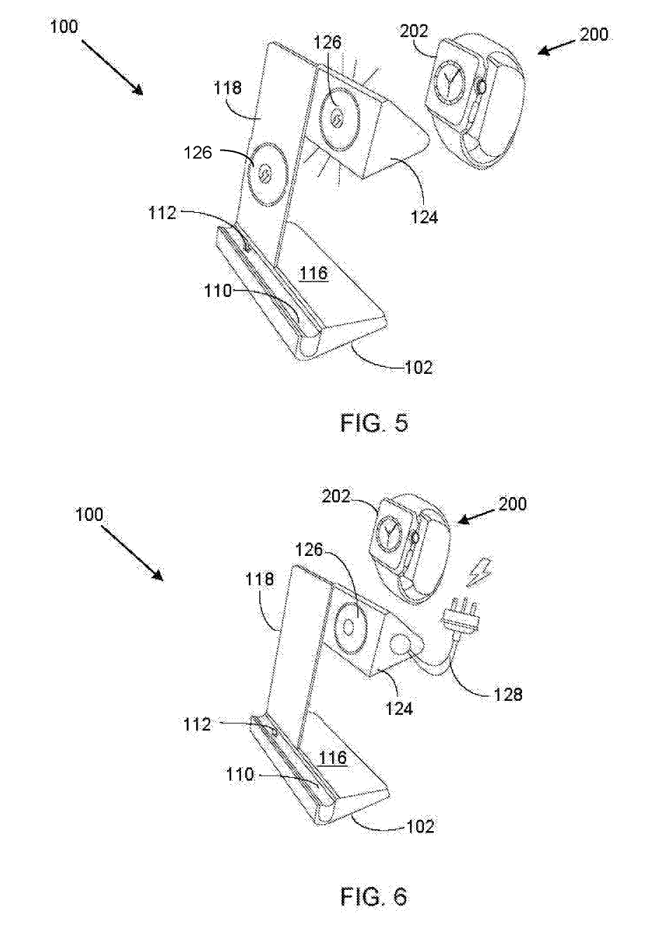

As shown in FIG. 5, the arm 124 further includes an inductive charging member 126 configured to transfer energy from the arm 124 to the computerized wristwatch 200, such that the computerized wristwatch 200 is recharged without the use of circuitry. The inductive charging member 126 is configured to directly engage a back portion on the watch base 202. In one embodiment, the inductive charging member 126 may include a circular shaped inductive coupler that matches a base 102 of the computerized wristwatch 200 for optimal energy transfer. The inductive charging member 126 utilizes an inductive coupling, so as to charge the computerized wristwatch 200. In this manner, an electromagnetic field easily transfers from the inductive charging member 126 to the computerized wristwatch 200.

In one alternative embodiment, shown in FIG. 5, the inductive charging member 126 positions on the post 118 to recharge a phone or tablet wirelessly. In yet another alternative embodiment, the inductive charging member 126 positions on the base 102 to recharge a phone or tablet wirelessly. In this configuration, the inductive charging member 126 is configured to directly engage a conductive conduit on the phone or tablet through an inductive coupling. In this manner, the phone or tablet may be charged without wiring.

As illustrated in FIG. 6, a power cable 128 extends from the stand 100 to transfer energy from a power source to the computerized wristwatch 200 for recharging. In some embodiments, the power cable 128 is configured to transfer energy from an external power source, such as a wall socket, to the computerized wristwatch 200. In another embodiment, the power cable 128 is configured to transfer energy from an internal power source in the arm 124 to the computerized wristwatch 200. The internal power source may include, without limitation, a lithium ion battery, a rechargeable battery, and a solar panel. The power cable 128 configured to stow inside the cavity, wherein the power cable 128 is hidden when the panel 116 overlays the opening 108 of the cavity.

In some embodiments, the stand 100 may include a cable management system that is enclosed under the panel 116 for organization of the power cable 128 and other circuitry in the stand 100. The cable management system may also include a protruding member 114 for the power cable 128 to wrap around, and a panel 116 to hide the power cable 128 and other circuitry. The protruding member 114 enables discreet winding of the power cable 128. This creates a clean, unobstructed view since cables are not visible.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A multipurpose charging and display stand for charging and displaying a computerized wristwatch, the stand comprising:
a base, the base defined by a mounting surface, at least four sidewalls, and an opening, the opening forming a cavity inside the base;
a groove, the groove disposed to extend along a longitudinal axis of the base;
a protruding member, the protruding member disposed to extend from the mounting surface into the cavity;
a panel, the panel disposed to detachably overlay the opening of the base;
a post, the post defined by a base end and an arm end, the base end configured to extend from the base at an angle;
an arm, the arm disposed to rotatably join with the arm end of the post at a generally perpendicular orientation, the arm defined by a substantially triangular shape, the arm further defined by a substantially a durable and flexible material composition;
an inductive charging member, the inductive charging member disposed on the arm, the inductive charging member configured to at least partially enable the transfer of energy from the arm; and
a power cable, the power cable configured to at least partially enable the transfer of energy from the arm, the power cable further configured to stow inside the cavity, wherein the power cable is substantially hidden from view when the panel overlays the opening of the cavity.

2. The stand of claim 1, wherein the stand is configured to display and charge a computerized wristwatch.

3. The stand of claim 2, wherein the computerized wristwatch is a smartwatch.

4. The stand of claim 3, wherein the smartwatch is an Apple™ watch and a Lightning™ watch.

5. The stand of claim 4, wherein the inductive charging member is configured to rotatably engage the computerized wristwatch for charging.

6. The stand of claim 5, wherein the inductive charging member operatively joins the arm to enable wireless charging of the computerized wristwatch.

7. The stand of claim 6, wherein the inductive charging member is configured to rotatably disengage the computerized wristwatch for enabling optimal viewing and operation of a display screen on the computerized wristwatch.

8. The stand of claim 7, wherein the power cable and the inductive charging member are configured to alternate charging functions.

9. The stand of claim 8, wherein the power cable carries energy from an external power source through the arm to the computerized wristwatch.

10. The stand of claim 1, wherein the power cable carries energy from an internal power source in the arm.

11. The stand of claim 1, wherein the base forms a generally tapered shape.

12. The stand of claim 1, wherein the at least four sidewalls comprise a cable notch, the cable notch configured to enable passage of the power cable from the cavity.

13. The stand of claim 1, wherein the groove comprises a groove latch.

14. The stand of claim 1, wherein the power cable is configured to wind around the protruding member for stowage.

15. The stand of claim 1, wherein the panel comprises a lip, the lip configured to enable secure fastening with the at least four sidewalls of the base.

16. The stand of claim 1, wherein the durable and flexible material composition of the arm is leather.

17. A multipurpose charging and display stand for charging and displaying a computerized wristwatch, the stand comprising:
a base, the base defined by a mounting surface, at least four sidewalls, and an opening, the opening forming a cavity inside the base;
a groove, the groove disposed to extend along a longitudinal axis of the base;
a protruding member, the protruding member disposed to extend from the mounting surface into the cavity;
a panel, the panel disposed to detachably overlay the opening of the base;
a post, the post defined by a base end and an arm end, the base end configured to extend from the base at an angle;
an arm, the arm disposed to rotatably join with the arm end of the post at a generally perpendicular orientation, the arm defined by a substantially triangular shape, the arm further defined by a substantially a durable and flexible material composition; and
an inductive charging member, the inductive charging member disposed on the arm, the inductive charging member configured to at least partially enable the transfer of energy from the arm.

18. The stand of claim 17, further including a power cable, the power cable configured to at least partially enable the transfer of energy from the arm, the power cable further configured to stow inside the cavity, wherein the power cable is substantially hidden from view when the panel overlays the opening of the cavity, wherein the power cable is configured to pass through the cable notch from the cavity.

19. The stand of claim 17, wherein the stand is configured to display and charge a computerized wristwatch.

20. A multipurpose charging and display stand for charging and displaying a computerized wristwatch, the stand comprising:
a base, the base defined by a mounting surface, at least four sidewalls, and an opening, the opening forming a cavity inside the base, the at least four sidewalls comprising a cable notch;
a groove, the groove disposed to extend along a longitudinal axis of the base;
a protruding member, the protruding member disposed to extend from the mounting surface into the cavity;
a panel, the panel disposed to detachably overlay the opening of the base, the panel comprising a lip, the lip configured to enable secure fastening with the at least four sidewalls of the base;
a post, the post defined by a base end and an arm end, the base end configured to extend from the base at an angle;
an arm, the arm disposed to rotatably join with the arm end of the post at a generally perpendicular orientation, the arm defined by a substantially triangular shape, the arm further defined by a substantially leather material composition;
an inductive charging member, the inductive charging member disposed on the arm, the inductive charging member configured to at least partially enable the transfer of energy from the arm; and
a power cable, the power cable configured to at least partially enable the transfer of energy from the arm, the power cable further configured to stow inside the cavity, wherein the power cable is substantially hidden from view when the panel overlays the opening of the cavity, wherein the power cable is configured to pass through the cable notch from the cavity.
